(19) United States
(12) Patent Application Publication
(10) Pub. No.: US 2010/0092376 A1
(43) Pub. Date: Apr. 15, 2010

(54) Manufacturing method of porous titanium dioxide using cyclodextrin

(75) Inventors: Seung-Yeop Kwak, Seoul (KR); Jae-Woo Chung, Seoul (KR)

Correspondence Address: JONES, TULLAR & COOPER, P.C., P.O. BOX 2266 EADS STATION, ARLINGTON, VA, 22202, US

(73) Assignee: Seoul National University Industry Foundation, Seoul (KR)

(21) Appl. No.: 11/989,631

(22) PCT Filed: May 29, 2007
(86) PCT No.: PCT/KR2007/002582

§ 371 Date: Jan. 29, 2008

(30) Foreign Application Priority Data
Nov. 30, 2006 (KR) 10-2006-0119438

(51) Int. Cl. C01G 23/053

(52) U.S. Cl. 423/610

(57) ABSTRACT

A method is provided for manufacturing porous titanium dioxide with uniform pore sizes within several nanometers by means of a template and a titanium precursor. In this method, a cyclodextrin or cyclodextrin derivative is used as a template for forming pores, and the cyclodextrin or then derivative reacts with the titanium precursor in a sulfuric acid solution. The manufacturing method according to the present invention allows the control of pore size and morphology using various kinds of cyclodextrin or cyclodextrin derivatives, supports a facile removal of the cyclodextrin used as the template, and is capable of manufacturing anatase type porous titanium dioxide with excellent photoactivity without a separate sintering process.

### TECHNICAL FIELD

The present invention relates to a manufacturing method of porous titanium dioxide, a material widely used as photocatalysts, electrodes for solar cells or adsorbents. In particular, it relates to a facile method that supports an easy control of the pore size and morphology of titanium dioxide, and is capable of producing porous titanium dioxide with uniform pore sizes within several nanometers and large specific surface areas.

### BACKGROUND ART

Since the report of the discovery of a hexagonal array of mesoporous silica, which was dubbed MCM-41 by scientists from Mobil Oil in 1992, active research has continued in this field. Silica molecular sieves of various structures with uniform pore sizes in the mesoporous domain (pore size 2-50 nm) have been synthesized, including MCM-48, KIT-1, MSU-1, MCM-41 and SBA-1, the last one having pore sizes belonging to a larger class despite belonging to the same space group as the others.

In manufacturing mesoporous silica molecular sieves, surfactant aggregates are mainly used as structure-directing agents, and among many mechanisms, a cooperative template mechanism suggested by a research group of G. D. Stucky at University of California—Santa Barbara is generally accepted. According to the mechanism, a complex between surfactant and silicate is formed and the silicate present on the surface of the micelles formed from the surfactant undergoes polymerization. This polymerization affects the structure of the complex, which may lead to a phase change. Therefore, by modifying the surfactant or diversifying reaction conditions such as reaction temperature or composition, mesoporous silica molecular sieves having various pore structures and sizes may be synthesized. Such mesoporous silica molecular sieves have exhibited their potential as absorbents and catalysts, and it has been reported that the mesoporous silica molecular sieves may be applicable in various other fields as the manufacture of a nano structured metal or a semiconductor material.

Such porous molecular sieves of high utility are not limited to porous silica, and metals capable of forming pores that have been disclosed so far include Al, Ga, Sn, Sb, V, Fe, Mn, Zr, Hf, W, Ti or Nb. In particular, when the molecular sieve structure incorporates pores from titanium dioxide (TiO₂), a well known photocatalyst, highly applicable molecular sieves with good surface area can be produced, thus such molecular sieves are widely studied.

Generally, an inhibitor for controlling polymerization of a titanium precursor and a surfactant for forming pores are used to manufacture the porous titanium dioxide. The polymerization of the titanium precursor proceeds too fast along with hydrolysis when the titanium precursor is in contact with water, so that titanium dioxide fails to grow into nanoparticles and other desired structures. The use of inhibitors was first suggested by Atonelli group in 1995 to solve this problem. A manufacturing method of the porous titanium dioxide using the inhibitor and the surfactant is described in detail as follows. The surfactant is dissolved in water of controlled pH, the titanium precursor and the polymerization inhibitor are added to form a complex of surfactant and titanium salt. Then, the titanium salt existing on the surface of a micelle of surfactant undergoes a slow polymerization due to the inhibitor to grow into a mesoporous molecular sieve. The surfactant is then removed, thereby obtaining porous titanium dioxide. The surfactant includes a cationic surfactant, an anionic surfactant or a neutral surfactant as a template for manufacturing the porous titanium dioxide.

As described above, it is known that the use of inhibitors or surfactants allows manufacture of porous titanium dioxide under various, suitable conditions. However, in the case that the surfactant is used as a template, there are many disadvantages. For example, it is not easy to manufacture porous titanium dioxide having uniform pores below several nanometers; it is difficult to completely remove the surfactant, or the pores are destroyed when the surfactant is removed through thermal decomposition.

### DISCLOSURE

### Technical Problem

The present invention is designed to solve the problems of the prior art, and therefore it is an object of the present invention to provide a manufacturing method of porous titanium dioxide with uniform pores below several nanometers and large specific surface area. This inventive method should not only provide an easy control of pore sizes, but also eliminate the need for a separate sintering process.

### Technical Solution

In order to achieve the above-mentioned objects, a manufacturing method of porous titanium dioxide includes the steps of: (S1) preparing a cyclodextrin or cyclodextrin derivative and a titanium precursor and (S2) reacting the cyclodextrin or cyclodextrin derivative with the titanium precursor in an aqueous sulfuric acid solution. More preferably, step (S2) is performed under the presence of a reaction inhibitor to control the rate of polymerization of the titanium precursor.

More preferably, the pH of the sulfuric acid solution is 1 to 2.

More preferably, the present method provides anatase porous titanium dioxide with excellent photoactivity by performing hydrothermal treatment of the product of step (S2).

More preferably, the method further includes performing hydrothermal treatment of the product of step (S2) to induce a spontaneous removal of the cyclodextrin or cyclodextrin derivatives used as the template.

The present invention provides an inventive method for manufacturing porous titanium dioxide with uniform pore sizes within several nanometers in a simple fashion. According to the inventive method, a spontaneous removal of the cyclodextrin takes place during the manufacture, which in turn leads to the formation of pores. This differs from conventional methods which produce pores by thermal decomposition of the surfactant after porous titanium dioxide is produced by means of the surfactant template. These conventional methods were able to produce pores only when severe means, i.e. those that may possibly affect the pores, were employed to remove the template. The present invention therefore has the built-in advantage of preventing the likelihood of destruction of the pores that may occur during the thermal decomposition. In addition, the method of the present invention produces anatase type porous titanium dioxide of good photoactivity with large specific surface area, widely used as photocatalysts, absorbents and electrodes of solar cells, without a separate sintering step using a hydrothermal treatment step.

### DESCRIPTION OF DRAWINGS

These and other features, aspects, and advantages of preferred embodiments of the present invention will be more fully described in the following detailed description, taken accompanying drawings. In the drawings:

FIG. 1 is a view illustrating a process for forming particles of porous titanium dioxide obtained according to a manufacturing method of the present invention.

FIG. 2 illustrates a powder X-ray diffraction result of the porous titanium dioxide manufactured according to an embodiment of the present invention, and shows a difference between ‘with hydrothermal treatment’ and ‘without hydrothermal treatment’.

FIG. 3 is a high resolution transmission electron microscope (HR-TEM) photograph of the porous titanium dioxide manufactured according to an embodiment of the present invention.

FIG. 4 is a crystallite phase photograph of the porous titanium dioxide manufactured according to an embodiment of the present invention that is verified through the HR-TEM photograph.

FIG. 5a is a field-emission scanning electron microscope (FE-SEM) photograph of 30,000 magnifications of the porous titanium dioxide manufactured according to an embodiment of the present invention, and FIG. 5b is a field-emission scanning electron microscope (FE-SEM) photograph of 50,000 magnifications of the porous titanium dioxide manufactured according to an embodiment of the present invention.

FIG. 6 is a thermogravimetric analysis (TGA) result curve of the porous titanium dioxide manufactured according to an embodiment of the present invention, titanium dioxide manufactured without using cyclodextrin, and cyclodextrin.

FIG. 7 is a BET (Brunauer-Emmett-Teller) absorption and desorption result curve of the porous titanium dioxide manufactured according to an embodiment of the present invention and the titanium dioxide manufactured without using cyclodextrin.

FIG. 8 is a BJH (Barret-Joyner-Halenda) result curve of the porous titanium dioxide manufactured according to an embodiment of the present invention and the titanium dioxide manufactured without using cyclodextrin.

### BEST MODE

Hereinafter, a manufacturing method of porous titanium dioxide of the present invention will be described in detail.
The present invention provides a manufacturing method of porous titanium dioxide including (S1) preparing cyclodextrin or cyclodextrin derivatives and a titanium precursor; and (S2) reacting the cyclodextrin or cyclodextrin derivatives with the titanium precursor in an aqueous sulfuric acid solution.

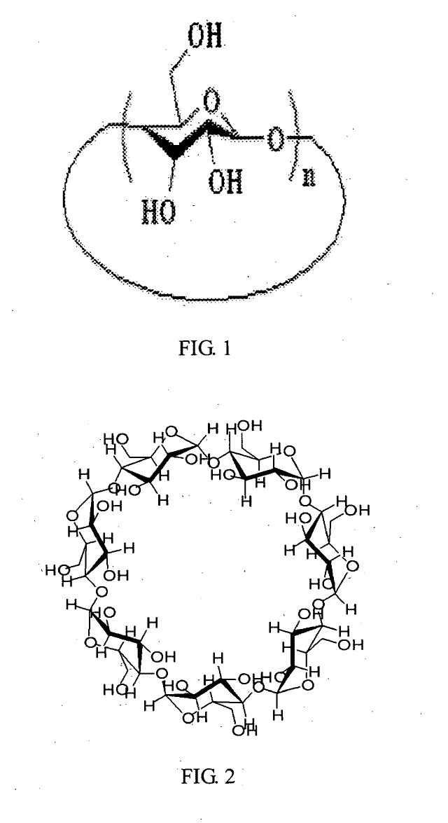

The manufacturing method of porous titanium dioxide of the present invention uses the cyclodextrin or cyclodextrin derivatives represented by the following Chemistry FIG. 1 as a template for forming pores.

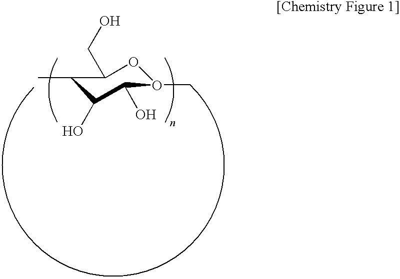

wherein n is an integer of 6 to 20.

As the template for forming pores, preferably cyclodextrin with n being 6 to 8, represented by the Chemistry FIG. 1 is used, and more preferably beta-cyclodextrin with n being 7, represented by the following Chemistry FIG. 2 is used.

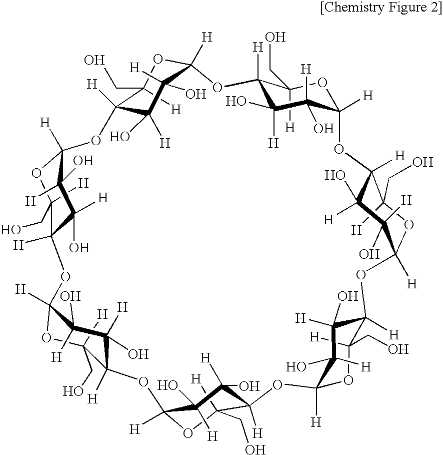

The cyclodextrin of the above Chemistry FIG. 1 is a cyclic compound comprised of repeating glucose units in the same manner as the beta-cyclodextrin of the above Chemistry FIG. 2. This cyclodextrin of Chemistry FIG. 1 has a hydrophilic outer part surrounded by a hydroxyl functional group and a hydrophobic inner cavity. For the case of beta-cyclodextrin, it is an organic nanoparticle 14 to 17 Å wide and 7.5 Å long in the shape of a corn, of which the end portion is cut out. In particular, the outer hydroxyl functional group of the cyclodextrin is compatible with a hydroxyl functional group of an inorganic material, and thus may be used as a template when forming inorganic nanoparticles. This technique may go beyond the conventional pore forming method using a surfactant, and manufacture a new-concept porous material having uniform and small-sized pores. And, the technique may use cyclodextrin or cyclodextrin derivatives of different morphologies and sizes as a template, thereby manufacturing various morphologies of porous titanium dioxide having uniform pores according to purposes of the porous titanium dioxide.

And, the cyclodextrin used in the present invention may be replaced by cyclodextrin derivatives, in which a portion of hydrogens from the hydroxyl functional groups in said cyclodextrin is substituted by such groups as halogen, alkyl having 1 to 100 carbon atoms, hydroxyalkyl having 1 to 100 carbon atoms, alkylcarboxyl having 1 to 100 carbon atoms, penyl, benzyl, penylalkyl having 1 to 100 carbon atoms, naphthyl having 0 to 100 carbon atoms, naphthylalkyl having 1 to 100 carbon atoms, sulphonyl having 0 to 100 carbon atoms, sulfoxide functional group having 0 to 100 carbon atoms or thiol having 0 to 100 carbon atoms, however the present invention is not limited in this regard. For example, cyclodextrin derivatives having increased hydrophilicity may be used to control the pore size of the porous titanium dioxide or to easily remove the cyclodextrin, and such cyclodextrin derivatives may include maltosyl-cyclodextrin, glucosyl-cyclodextrin, methylated-cyclodextrin or hydroxypropyl-cyclodextrin, however the present invention is not limited in this regard.

Typically, the titanium precursor used in the manufacturing method of the present invention may be Ti(R)₄, wherein generally R may include alkoxide having 1 to 100 carbon atoms or halogen having 0 to 100 carbon atoms, however the present invention is not limited in this regard, and preferably R is titaniumisopropoxide.

As shown in FIG. 1, the titanium precursor generates polymerization outside of the cyclodextrin while surrounding the cyclodextrin, and after the polymerization, the cyclodextrin escapes naturally to form porous titanium dioxide.

And, to improve interaction between the cyclodextrin and the titanium precursor, the manufacturing method of porous titanium dioxide of the present invention generates polymerization under the presence of a sulfonate functional group (SO₄²⁻), and performs the reaction of step (S2) in a sulfuric acid solution under this condition.

The sulfonate functional group of the present invention may improve interaction between the cyclodextrin and the titanium precursor to induce polymerization while surrounding the cyclodextrin, thereby facilitating the manufacture of porous titanium dioxide. More specifically, when the titanium precursor contacts with water, the titanium precursor is hydrolyzed, and polymerization proceeds in an acidic condition to yield polymerized titanium (—O—Ti—O—)ₙ, which exhibits cationic characteristics, while the hydroxyl functional group of the cyclodextrin also exhibits cationic characteristics under the acidic condition. The sulfonate functional group serves as a medium for a strong interaction between the cations, so that crystallites grow around the cyclodextrin to form crystallites of porous structure.

Preferably, the pH of the sulfuric acid solution in step (S2) of the present invention is 0.5 to 4.5, more preferably 1 to 2, and most preferably about 1.5. In the case that pH is less than 0.5, polymerization proceeds slowly, and in the case that pH is more than 4.5, polymerization proceeds fast, thereby failing in obtain a desired porous structure.

And, preferably the mole ratio between the cyclodextrin and the titanium precursor is 1:0.5 to 1:12, and more preferably 1:1, 1:3 and 1:6. In the case that the mole ratio is less than 1:1, the yield is too small, and in the case that the mole ratio is more than 1:6, the crystallite morphology changes from a sphere to a plate, thereby reducing the specific surface area of the porous titanium dioxide.

More preferably, the present invention provides a manufacturing method of porous titanium dioxide, in which polymerization of the (S2) step proceeds under the presence of a reaction inhibitor for controlling the polymerization rate. The reaction inhibitor may include acetylacetone, glacial acetic acid, ethylene glycol or hydrolyzed water, however the present invention is not limited in this regard, and preferably the reaction inhibitor is acetylacetone.

In the case that the reaction inhibitor is not used, polymerization proceeds too fast together with hydrolysis when the titanium precursor reacts with water, and thus it is difficult for the titanium dioxide to grow into a desired structure.

Preferably, the mole ratio between the titanium precursor and the reaction inhibitor is 1:1 to 1:2. In the case that the mole ratio is less than 1:1, a reaction inhibiting effect is too small, and in the case that the mole ratio is more than 1:2, the reaction proceeds too much slowly, thereby failing in obtaining a desired porous structure.

More preferably, the manufacturing method of porous titanium dioxide of the present invention may further include a hydrothermal treatment step for performing hydrothermal treatment of a product obtained after step (S2). Preferably, the hydrothermal treatment is performed at the temperature of 50° C. or more, more preferably about 70° C. or more, and most preferably about 90° C. or more. The hydrothermal treatment may remove the cyclodextrin or cyclodextrin derivatives used as a template more effectively, and manufacture porous titanium dioxide having anatase type crystallite without a separate sintering process.

According to the present invention, a precision-controlled manufacture of anatase type porous titanium dioxide is possible by adjusting such factors as the mole ratio between the cyclodextrin and the titanium precursor, use of the reaction inhibitor, concentration of acid and hydrothermal treatment. Such porous titanium dioxide not only has uniform pore size but also large specific surface area, and thus may be used in various fields, for example photocatalysts, absorbents, electrodes of solar cells, purifying agents for various contaminants, germicidal agents, deodorants, carriers of cosmetics and pharmaceuticals, tooth whiteners, or pollution-preventing agent for building materials.

### MODE FOR INVENTION

Hereinafter, embodiments are described in detail for understanding of the present invention. However, it should be understood that the detailed description and specific examples, while indicating preferred embodiments of the invention, are given by way of illustration only, since various changes and modifications within the spirit and scope of the invention will become apparent to those skilled in the art from this detailed description.

### Embodiment 1

### Synthesis of Porous Titanium Dioxide Using Beta-Cyclodextrin as a Template

3 g of beta-cyclodextrin dried at 80° C. for at least one day was dissolved in 200 ml of a sulfuric acid solution of 1.5 pH contained in a 500 ml glass bottle with a cover, and was agitated at room temperature using an agitator. Subsequently, titaniumisopropoxide measured three times the mole ratio of the beta-cyclodextrin was mixed with acetylacetone as the reaction inhibitor at a ratio of 1:1, and agitated for ten minutes. Next, the yellow titaniumisopropoxide-acetylacetone solution is slowly added to the beta-cyclodextrin solution, and then agitated at room temperature for twenty four hours or more with the glass bottle being closed with the cover. Then, a hydrothermal reaction is performed at 90° C. for three hours. The product was obtained using a centrifuge, and washed with 400 ml of distilled water twice and 400 ml, of acetone once. A resultant product was placed into a vacuum oven and dried at room temperature for twelve hours or more.

### Embodiment 2

### Synthesis of Porous Titanium Dioxide Using Methyl Beta-Cyclodextrin (DS=About 1.8 to 2) as the Template, in which Twelve to Eighteen Hydroxyl Functional Groups Among Twenty One Hydroxyl Functional Groups of Beta-Cyclodextrin are Substituted by Methyl Functional Groups

The porous titanium dioxide of this embodiment is synthesized in the same method as the embodiment 1, except that instead of the beta-cyclodextrin, methyl beta-cyclodextrin is used as a template, in which twelve to eighteen hydroxyl functional groups among twenty one hydroxyl functional groups of beta-cyclodextrin are substituted by methyl functional groups.

### Embodiment 3

### Synthesis of Porous Titanium Dioxide Using Alpha-Cyclodextrin as a Template

The porous titanium dioxide of this embodiment is synthesized in the same method as the embodiment 1, except that instead of the beta-cyclodextrin, alpha-cyclodextrin is used as a template.

### Embodiment 4

### Synthesis of Porous Titanium Dioxide Using Gamma-Cyclodextrin as a Template

The porous titanium dioxide of this embodiment is synthesized in the same method as the embodiment 1, except that instead of the beta-cyclodextrin, gamma-cyclodextrin is used as a template.

### Experimental Example

### Structure Analysis of Porous Titanium Dioxide

Synthesis of the porous titanium dioxide of the present invention is verified by analyzing crystallite size and morphology using X-ray diffraction (XRD), its porosity and pore morphology are checked through high-resolution transmission electron microscopy (HR-TEM) and field effect scanning electron microscopy (FE-SEM) photographs, and removal of the cyclodextrin used as the template is judged through a thermogravimetric analysis (TGA) curve. Further, a specific surface area and pore size are checked through a BET absorption and desorption curve and a BJH result.

### Experimental Example 1

### XRD Measurement

The crystallite structure and size of the porous titanium dioxide synthesized in the above embodiments are checked using XRD. XRD pattern is measured to 5 to 60° at the speed of 5° ?per minute through MAC/Sci. MXP 18XHF-22SRA diffractometer (50 kV/100 mA) that uses Cu K_{α} radiation (λ=0.1541 nm) as X-ray. A result of the embodiment 1 is shown in FIG. 2.

According to analysis of peaks shown in FIG. 2, it is found through the peaks (101), (004), (200), (105) and (210) that, before the hydrothermal treatment, the titanium dioxide does not show crystallite phase, but after the hydrothermal treatment, a titanium dioxide photocatalyst having anatase type crystallite, known to have good photoactivity, is manufactured. In particular, the crystallite size of the titanium dioxide is measured using Scherrer equation of the following Math FIG. 1, and a result of the embodiment 1 is shown in the following Table 1.

$$Φ = \frac{K λ}{β cos θ} \qquad [ Math Figure 1 ]$$

wherein Φ is crystallite size, K is 0.89, λ is wavelength (0.1541 nm) of X-ray radiation, β is full width at half maximum intensity (FWHM), and ? is a diffraction angle at peak (101) for anatase.

TABLE 1

| Mole Ratio | | |
|---|---|---|
| (CD:Titanium | | |
| Precursor) | β | Φ(nm) |
| 1:3 | 0.990 | 8.1 |

### Experimental Example 2

### HR-TEM Measurement

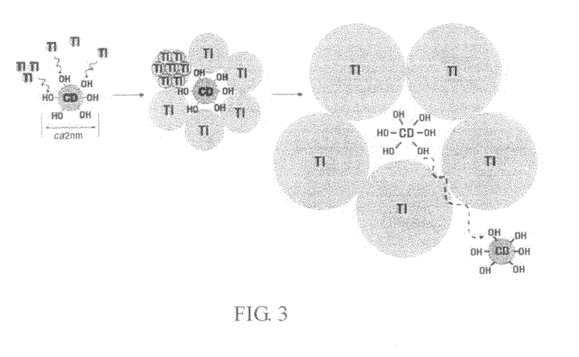

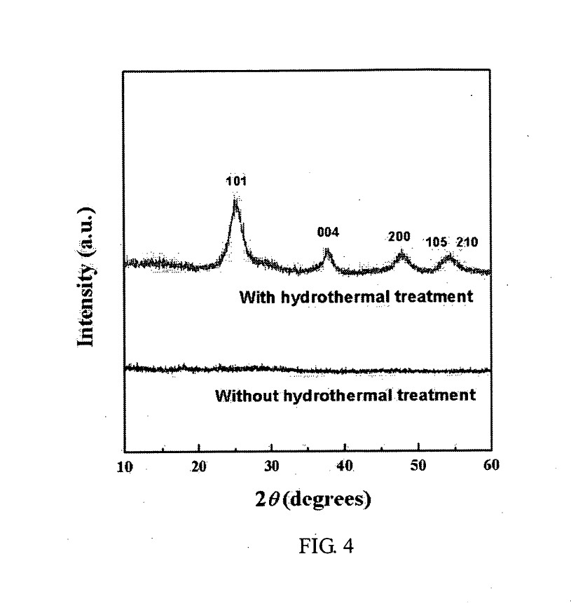

The porosity of the synthesized titanium dioxide is analyzed using HR-TEM. HR-TEM image is obtained using JEM-3010 (300 kV). For HR-TEM analysis, 0.03 g of the synthesized porous titanium dioxide is put in 10 ml of ethanol, and ultrasonic wave treatment is performed for ten minutes to prepare a disperse solution. A carbon film-treated copper grid is contacted with the disperse solution for several seconds and dried at room temperature to prepare a sample. The result of the embodiment 1 is shown in FIGS. 3 and 4.

As shown in FIG. 3, in the synthesized titanium dioxide, primary particles having size of 10 nm or less are clustered into secondary particles of micrometer size, and a worm-like pore structure is generated between the primary particles. As shown in FIG. 4, a photograph observed by HR-TEM illustrates that crystallite phase is formed in the synthesized titanium dioxide.

### Experimental Example 3

### FE-SEM Measurement

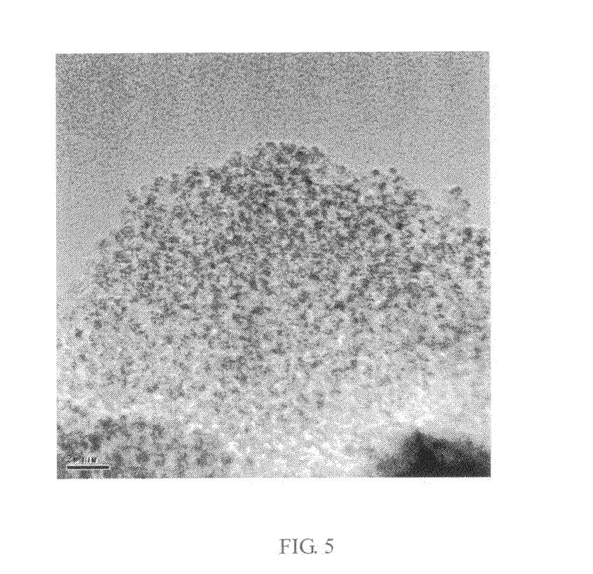

The morphology of the synthesized titanium dioxide is analyzed using FE-SEM. FE-SEM image is obtained using JSM-6330F (5 kV/12 uÅ) made by JEOL. For obtaining the FE-SEM image, a small amount of the synthesized porous titanium dioxide is put on an adhesive carbon tape, and coated with white gold for five minute to prepare a sample. FIGS. 5a and 5b illustrating FE-SEM images of 30,000 magnifications and 50,000 magnifications, respectively, show that primary particles of 10 nm or less are clustered into spheric secondary particles of about 1 to 2 μm.

### Experimental Example 4

### TGA Measurement

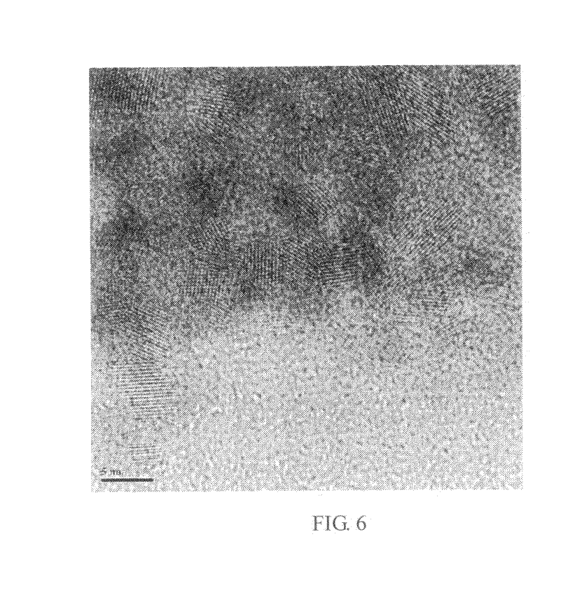

TGA is used to check whether or not the cyclodextrin used as the template exists in the synthesized porous titanium dioxide. (a) of FIG. 6 shows a result of the beta-cyclodextrin, (b) shows a result of the porous titanium dioxide obtained by synthesizing the beta-cyclodextrin and the titanium precursor at a ratio of 1:3 according to the embodiment 1, and (c) shows a result of titanium dioxide synthesized using only the titanium precursor in the same method as the embodiment 1 without using beta-cyclodextrin. At this time, (c) is a sample for comparison with the titanium dioxide manufactured by synthesizing the beta-cyclodextrin and the titanium precursor at a ratio of 1:3, and the same amount of titanium precursor and synthesis method are applied therebetween. The result is shown in FIG. 6.

As shown in (a) of FIG. 6, the beta-cyclodextrin itself is hydrolyzed around 100° C. and decomposed on the approach to 300° C. And, as shown in (c) of FIG. 6, the titanium dioxide manufactured by using only the titanium precursor does not show a decomposition TGA curve. However, as shown in (b) of FIG. 6, the titanium dioxide manufactured by synthesizing the beta-cyclodextrin and the titanium precursor at a mole ratio of 1:3 does not show a beta-cyclodextrin decomposition TGA curve at 300° C., but a TGA curve similar to (c) of FIG. 6. This means that the beta-cyclodextrin used as a template for forming pores is naturally removed during the manufacture of the porous titanium dioxide and does not exist in the porous titanium dioxide any longer, and the porous titanium dioxide is provided with porosity.

### Experimental Example 5

### Measurement of Specific Surface Area Through BET and Measurement of Pore Size Through BJH

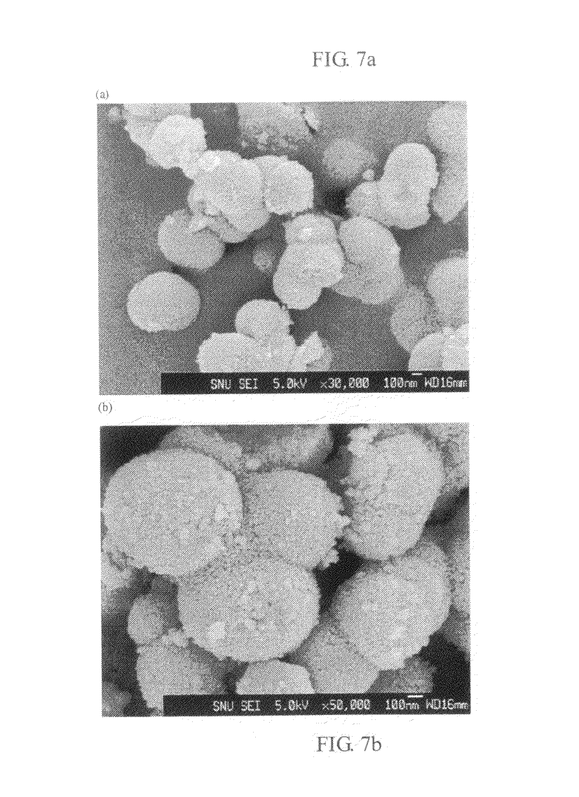

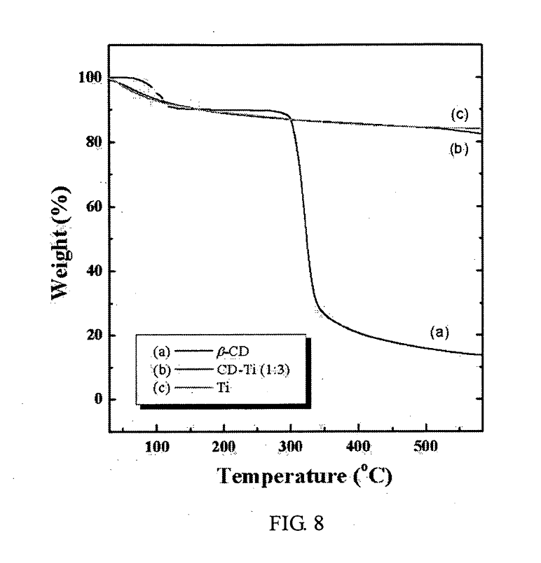

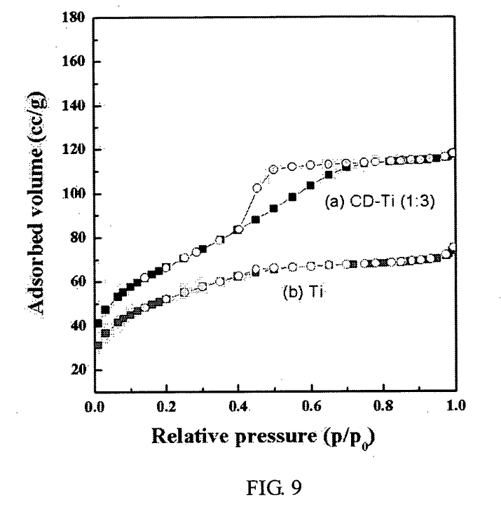

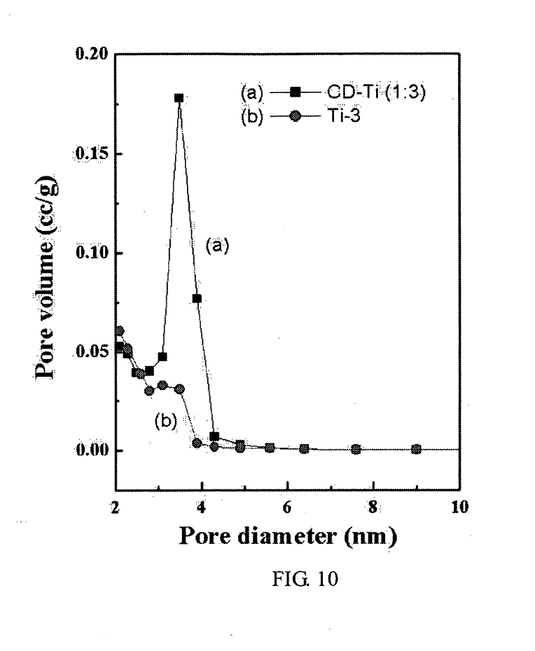

The specific surface area and porous structure of the synthesized porous titanium dioxide are measured through a BET absorption curve, of which result is shown in FIG. 7, and the pore size is measured through a BJH curve, of which result is shown in FIG. 8. In FIGS. 7 and 8, (a) corresponds to the porous titanium dioxide manufactured by synthesizing the beta-cyclodextrin and the titanium precursor at a ratio of 1:3 according to the embodiment 1, and (b) corresponds to the titanium dioxide synthesized by using only a titanium precursor without beta-cyclodextrin. At this time, (b) is a sample for comparison with the porous titanium dioxide manufactured by synthesizing the beta-cyclodextrin and the titanium precursor at a ratio of 1:3, and the same amount of titanium precursor and synthesis method are applied therebetween.

As shown in FIG. 7, (a) shows a hysteresis curve, in which an absorption curve of nitrogen is inconsistent with a desorption curve of nitrogen. This means that the titanium dioxide manufactured by synthesizing the beta-cyclodextrin and the titanium precursor at a ratio of 1:3 has a porous structure. (b) shows that an absorption curve of nitrogen is consistent with a desorption curve of nitrogen, which means a porous structure is not formed. Due to the porous structure, (a) has larger specific surface area than (b) by about 50 cc/g.

According to BJH result of FIG. 8, pores having size of about 3.3 nm are measured in (a), whereas any pore is not measured in (b).

The result is shown in the following Table 2.

TABLE 2

| | Specific | |
|---|---|---|
| | Surface | Pore |
| | Area | Size |
| Classification | (cc/g) | (nm) |
| (a) CD-Ti (1:3) | 238.05 | 3.3 |
| (b) Ti | 186.00 | — |

By comparing titanium dioxide manufactured under the existence of beta-cyclodextrin with titanium dioxide manufactured without beta-cyclodextrin, it is found that beta-cyclodextrin is used as a template for forming pores, and anatase type porous titanium dioxide having good photoactivity is properly synthesized through hydrothermal treatment.

### INDUSTRIAL APPLICABILITY

As such, the present invention may manufacture porous titanium dioxide with uniform pore sizes within several nanometers in a simple manner, eliminate the need for an additional process for removing a material used as a template, and manufacture anatase type porous titanium dioxide with excellent photoactivity without a separate sintering process.

1. A manufacturing method of porous titanium dioxide, comprising the steps of:
(S1) preparing a cyclodextrin or cyclodextrin derivative and a titanium precursor; and
(S2) reacting the cyclodextrin or cyclodextrin derivative with the titanium precursor in an aqueous sulfuric acid solution.

2. The manufacturing method of porous titanium dioxide according to claim 1,
wherein the step (S2) is performed in the presence of a reaction inhibitor to control the rate of polymerization of said titanium precursor.

3. The manufacturing method of porous titanium dioxide according to claim 2,
wherein the reaction inhibitor is at least one selected from the group consisting of acetylacetone, glacial acetic acid, ethylene glycol, and hydrolyzed water.

4. The manufacturing method of porous titanium dioxide according to claim 2,
wherein the mole ratio between the titanium precursor and the reaction inhibitor (titanium precursor:reaction inhibitor) is 1:1 to 1:2.

5. The manufacturing method of porous titanium dioxide according to claim 1,
wherein the pH of the sulfuric acid solution is 1 to 2.

6. The manufacturing method of porous titanium dioxide according to claim 1,
wherein the cyclodextrin is at least one selected from the group consisting of alpha-cyclodextrin, beta-cyclodextrin and gamma-cyclodextrin.

7. The manufacturing method of porous titanium dioxide according to claim 1,
wherein the mole ratio between the cyclodextrin and the titanium precursor (cyclodextrin:titanium precursor) is 1:0.5 to 1:12.

8. The manufacturing method of porous titanium dioxide according to claim 1, further comprising:
performing a hydrothermal treatment of the product from step (S2).
